(19) United States
(12) Patent Application Publication
(10) Pub. No.: US 2007/0206456 A1
(43) Pub. Date: Sep. 6, 2007

(54) TRAJECTORY MAPPING FOR IMPROVED MOTION-SYSTEM JITTER WHILE MINIMIZING TRACKING ERROR

(76) Inventors: Jeffrey S. Sullivan, Castro Valley, CA (US); Benyamin Buller, Cupertino, CA (US); Eugene Mirro JR., San Leandro, CA (US); William A. Eckes, Castro Valley, CA (US)

Correspondence Address: PATTERSON & SHERIDAN, LLP, 3040 POST OAK BOULEVARD, SUITE 1500, HOUSTON, TX, 77056, US

(21) Appl. No.: 11/537,054

(22) Filed: Sep. 29, 2006

Related U.S. Application Data
(60) Provisional application No. 60/722,654, filed on Sep. 30, 2005.

(51) Int. Cl. G11B 7/00

(52) U.S. Cl. 369/44.29

(57) ABSTRACT

Methods and apparatus to compensate for low-frequency tracking errors in motion control of a movable stage are provided. By recording tracking errors during earlier traversal of a trajectory, filtering, and applying those recorded tracking errors to subsequent traversals of the same or a similar trajectory, tracking errors of the subsequent traversals may be significantly reduced.

### CROSS-REFERENCE TO RELATED APPLICATIONS

This application claims benefit of U.S. provisional patent application Ser. No. 60/722,654 (APPM/010513L), filed Sep. 30, 2005, which is herein incorporated by reference.

### BACKGROUND OF THE INVENTION

1. Field of the Invention

Embodiments of the present invention generally relate to the field of motion control and, particularly, to controlling the movement of a stage, such as that utilized in charged particle beam systems.

2. Description of the Related Art

Movable stages designed to hold workpieces are utilized in a variety of applications. As an example, in charged particle beam systems, stages (movable in X and Y directions) are used to position workpieces relative to a charged particle beam, such as an electron beam. The workpiece may be a substrate that is being inspected or that has a material layer in which a pattern is being formed via exposure to the beam. In either case, in order to obtain an accurate image or accurately write a pattern, it is important to precisely control the position of the workpiece relative to the beam.

Therefore, such systems typically utilize some type of motion control mechanism that controls movement of the stage. The objective of the motion control mechanism is to cause the position of the stage to follow a desired position profile or “command” position. The motion control system typically controls movement of the stage via command signals sent to some type of DC servo motor controller, while it monitors the actual position via a position monitoring system (such as an interferometer system). The complete control path (or loop) to the servo motor with feedback from the position monitoring system is generally referred to as the servo loop.

A measure of the success of the motion control mechanism is the tracking error, which is typically calculated as the difference between the desired (command) position and the actual position. To improve the tracking error, loop gain is typically increased and/or bandwidth of the servo loop is increased by increasing the gain of the servo controller. In many systems, increasing the controller gain will increase the servo bandwidth and cause the controlled system to track higher frequencies in the command and feedback.

In many systems, the total tracking error is not the only consideration, as the frequency content of the tracking error is important. For example, it may be desirable to track low-frequency commands and feedback very accurately while attenuating high-frequency commands and feedback (e.g., by reducing controller gain). However, while this may reduce low frequency components of the tracking error, it is typically at the expense of increased high frequency components of the tracking error.

Accordingly, what is needed is an improved motion control mechanism that reduces tracking error over a wide range of frequency components.

### SUMMARY OF THE INVENTION

Embodiments of the present invention provide methods and apparatus for improving tracking error in a wide variety of motion control applications.

One embodiment provides a method of reducing tracking errors in a motion control mechanism. The method generally includes recording tracking errors during one or more traversals of one or more trajectories by a stage, generating a positional error to control movement of the stage during a subsequent traversal of a similar or different trajectory, and adjusting the positional error based on at least one of the recorded tracking errors. The adjusted positional error may be utilized to control the movement of the stage to a position during the subsequent traversal.

Another embodiment provides a method of reducing tracking errors in a motion control mechanism. The method generally includes recording tracking errors during one or more traversals of one or more trajectories by a stage, filtering the recorded tracking errors to remove high frequency tracking components, and applying the filtered tracking errors to adjust position commands during subsequent passes along a similar trajectory.

Another embodiment provides a system for reducing tracking errors in a motion control mechanism. The system comprises a stage, a stage controller, and a systematic noise compensation logic adapted to record and process position errors during movement of the stage along a trajectory for use in compensating subsequent movement along the same or a similar trajectory.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary motion control mechanism in accordance with one embodiment of the present invention;

FIG. 2 illustrates an exemplary motion control mechanism in accordance with another embodiment of the present invention; and

FIG. 3 illustrates exemplary low pass filtering in accordance with one embodiment of the present invention.

To facilitate understanding, identical reference numerals have been used wherever possible, to designate identical elements that are common to the figures. It is contemplated that elements and/or process steps of one embodiment may be beneficially incorporated in other embodiments without additional recitation.

### DETAILED DESCRIPTION

Embodiments of the present invention may be utilized to improve tracking error in a wide variety of motion control applications. For some embodiments, controller gain may be reduced, minimizing high frequency components of the tracking error, at the expense of low-frequency tracking. However, increases in low-frequency tracking error may be compensated for by recording tracking errors during traversal of a common trajectory, low-pass filtering the recorded tracking errors, and applying the filtered tracking errors to adjust position commands during a subsequent pass along a similar trajectory.

In other words, the subsequent trajectory may be “reshaped” by the error in the previous trajectory. This approach may be effective because certain types of low frequency noise tend to be repeatable. As an example, if a stage is moving along a track at 50 millimeters per second, and encounters bolts of bearings every 50 millimeters that cause a positional error (e.g. if the bolts were overly tightened, thereby deforming the bearing), 1 Hz noise will be evident. Further, this type of low frequency noise tends to be systematic, with the noise correlated strongly with the position of the stage. In contrast, high frequency noise components (e.g., due to electronic noise sources such as beam deflection electronics and vibration) tend to be more random and have less correlation to position.

Embodiments of the present invention will be described below with reference to moving a stage in a charged particle beam system, as a particular, but not limiting, example of a suitable application thereof. However, those skilled in the art will recognize that the concepts described herein may be applied to control motion of a variety of different type objects in a variety of different types of applications. Further, while positional control loops will be described in detail, those skilled in the art will recognize that the concepts described herein may also be used to advantage in velocity and acceleration control loops.

### An Exemplary System

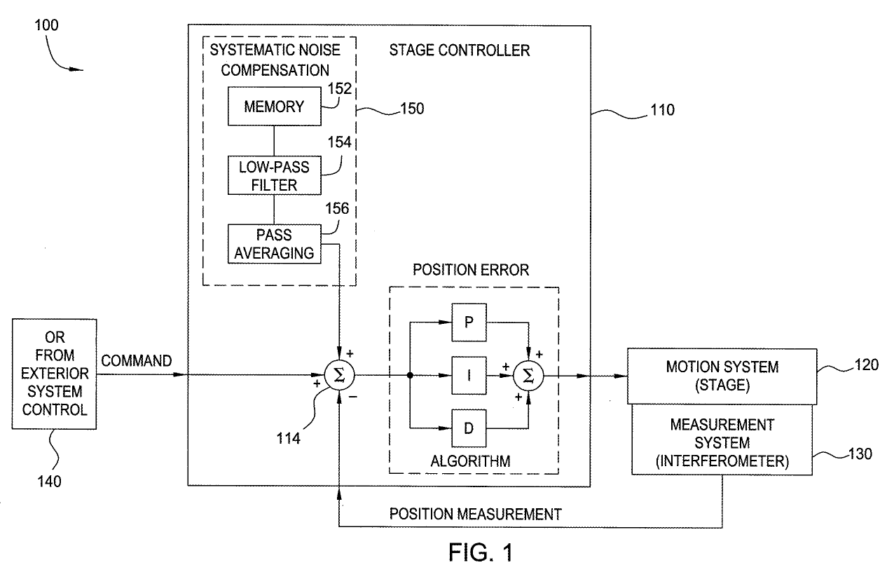

FIG. 1 illustrates a block diagram of an exemplary motion control mechanism 100 in accordance with one embodiment of the present invention. As illustrated, a stage controller 110 generates control signals to move a stage along a desired trajectory. For some embodiments, the stage may include a motor (not shown) that moves the stage along on a track or bearings, in both X and Y directions.

As illustrated, the stage controller 110 may receive position commands from an external system control computer 140. For example, in a charged particle beam control system, the system control computer 140 may perform various functions, such as moving the stage 120 to position a target (not shown) held thereon relative to a beam (not shown). In conjunction with moving the stage 120, the system control computer 140 may generate control signals to control a beam deflection system (not shown) to deflect the beam in an effort to precisely control the position of the beam during a scan.

The stage controller 110 may utilize any number of suitable algorithms to move the stage along a desired trajectory specified by a command received from the computer 140. For some embodiments, the stage controller 110 may receive trajectory input (via commands from the system control computer 140) in a point-by-point or point-to-point format. According to a point-to point format, the beginning and ending points are given, but points in between are not part of the command. In contrast, according to a point-by-point scheme, many points are given along the trajectory, for example, in distance or time intervals (e.g., every millimeter or second).

As illustrated, a position measurement system 130 (e.g., a laser interferometer system) may provide the stage controller 110 with real time position measurements. The stage controller 110 may subtract the position measurement from the command position (the position indicated in a command) to generate the position error. This position may be acted on in accordance with a control algorithm implemented by the controller, illustratively a proportion-integral-differential (PID) loop algorithm, to generate an output signal to move the stage. As the stage reacts to the signal, the position is again measured by the measurement system 130 and fed back to the stage controller 110.

### Utilizing Systematic Position Error

As previously described, high frequency components of the position error, such as those caused by beam deflection electronics and/or vibration, may tend to be more random and not correlated to any position. On the other hand, low frequency components may be less random and more correlated with position. This may be due to the fact that, in a number of different applications involving mechanical stages, the stage may be repeatedly moved along the same or similar trajectory and, therefore, subject to the same or similar mechanical influences that cause noise at the same or similar position (i.e., systematic errors).

As an example, for some charged particle beam systems, a raster pattern may be traced out with the stage. In such systems, the stage may be swept along one direction (e.g., along the X-axis) in order to scan an entire length (referred to as a “scan line” or “stripe”) of a workpiece held on the stage. After one scan line, the stage may be moved incrementally in another direction (e.g., along the Y-axis), and another line is scanned. Due to the relatively small increment in Y, the nature of the errors along the X-axis while scanning a subsequent stripe will not likely change significantly. In other words, the errors will likely maintain the same correlation to X positions in light of the relatively small change in the Y position.

Embodiments of the present invention may take advantage of the systematic (repeatable) nature of these low frequency errors to compensate for low frequency noise resulting in position errors. As illustrated in FIG. 1, for some embodiments, the stage controller 110 may include systematic noise compensation logic 150 generally configured to record and process position errors during movement of the stage 120 along a trajectory for use in compensating subsequent movement along the same or a similar trajectory.

The noise compensation logic 150 may effectively “reshape” the trajectory to compensate for the systematic errors by adding the recorded/processed errors back in at a summing block 114 when generating the position error to feed to the control algorithm. In other words, while the summing block in conventional systems generates a position error by subtracting the measured position from the command position, the illustrated embodiment effectively adds back in previously recorded positional errors corresponding to the same or similar position. As a result, the systematic noise compensation logic effectively “remembers” the noise encountered at the same (or similar) position during a previous traversal of the same (or similar) trajectory and adjust the current position error accordingly.

As illustrated, the systematic noise compensation logic 150 may include memory 152 to store position errors calculated as the stage makes one or more passes along a common trajectory or similar trajectories. For some embodiments, the position errors may be stored in a lookup table, allowing for position errors to be easily retrieved given their corresponding position. For example, when controlling movement of a stage to a position along a trajectory, a previously recorded tracking error corresponding to that position may be retrieved from the lookup table in memory 152 and used to adjust the positional error used by the control algorithm. In such embodiments, it may be preferable to utilize a point-by-point scheme where multiple points along a trajectory are supplied in a command, allowing multiple recorded positional errors to be retrieved and utilized for compensation.

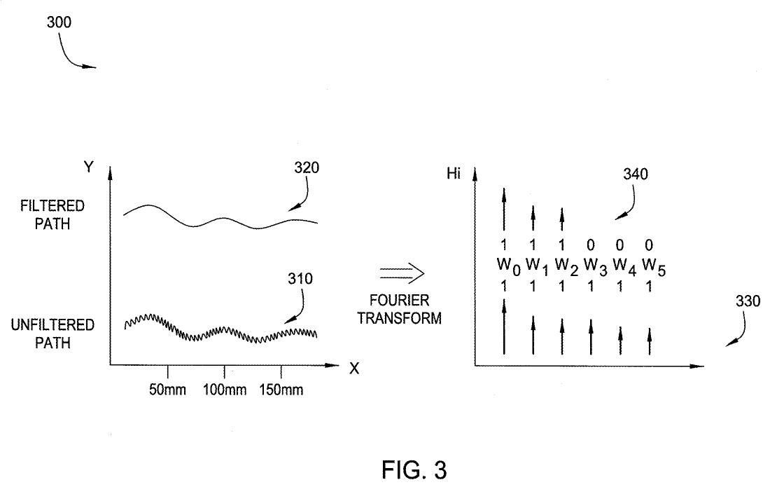

Because positional errors from previous scans are used to correct subsequent scans, various processing steps may be performed “offline” that might not be possible in conventional systems that only utilize “real time” positional errors. As an example, for some embodiments, low pass filtering logic 154 may apply some type of relatively complex low pass filtering to remove high frequency components of the recorded positional errors. As will be described in greater detail below with reference to FIG. 3, digital Fast Fourier Transforms (FFTs) may be utilized to accomplish near ideal low-pass filtering.

Further, in some cases, to compensate for gradual changes in the positional correlations (e.g., repeating errors correlated to positions along the X-axis) as stripes are scanned (and the Y position changes), tracking errors for a plurality of (N) passes may be recorded in memory 152 and pass averaging logic 156 may generate a “running average” of errors over multiple stripes or apply a simple coefficient multiplier. Therefore, the memory 152 may be considered an adaptive memory, as it continuously records tracking errors for the last few passes. For some embodiments, the number of passes N averaged may be adjustable (e.g., via some type of software interface). As an example, if N is set to four, tracking errors for four passes may be recorded and averaged.

As illustrated, it is the filtered and/or averaged position error that may be used for compensation. Accordingly, for some embodiments, the tracking errors in memory 152 may be initialized to zero, for example, until a history is recorded. As such, there may be no compensation until a sufficient number of passes has occurred to generate an adequate number of recorded tracking errors.

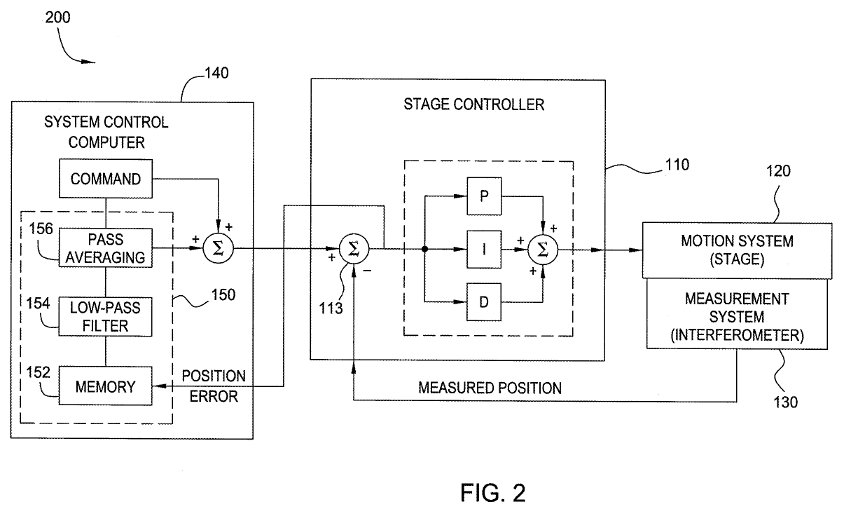

For some embodiments, the systematic noise compensation logic 150 may be moved outside of the controller. FIG. 2 illustrates an exemplary motion control mechanism 200 in accordance with another embodiment of the present invention As illustrated in FIG. 2, the systematic noise compensation logic 150 (and/or corresponding functions) may be moved to the system control computer 140, but with similar end result. The primary difference is that the position error summing function (that takes into consideration measured position, command position, and historical/lookup table positional error) has been split into two different summing blocks. As a result, in this implementation it may be easier to see how the command trajectory is modified by the position error recorded from the previous trajectories.

In other words, the recorded position errors may be used to adjust, with summing block 115, the actual trajectory positions included in commands sent from the system control computer 140 to the stage controller 110. The net result will be the same as in FIG. 1, however, once summing block 113 in the stage controller 110 subtracts out the position measurement from the already-adjusted command position received from the system control computer 140.

### Exemplary Low Pass Filtering

The compensation described herein may be particular effective by limiting corrections to low frequency components because, at low frequencies, the stage servo control loop may have very small phase error. In other words, at low frequencies, the servo loop may track nearly perfectly the command positions. In contrast, if corrections are attempted at higher frequencies, where the servo loop may have higher phase error (e.g., 30 degrees or more), the servo loop may not track the command positions as well.

This low pass filtering may take advantage of the fact that in mechanical systems, real mechanical tracking errors tend to be limited to a frequency band well below the mechanical resonant frequency of the system (e.g., typically 100 Hz or less). On the other hand, high frequency tracking errors (>100 Hz) tend to result from the control system and not from the mechanical system. Further, at low frequencies, tracking errors tend to be repeatable or slowly changing with time. As an example, with an X-Y stage, low frequency tracking errors are typically caused by errors such as bearing straightness (or lack thereof), which are repeatable (i.e., they do not change from pass to pass along the same trajectory).

According to some embodiments, because processing is done “offline” on positional errors recorded from previous trajectory passes, conventional time constraints that typically limit filtering to relatively simple algorithms are lifted and non-conventional low pass filters may be applied. As a result, while conventional low pass filters may create phase errors that reduce the effectiveness of the correction, offline digital processing may result in near ideal filtering.

For example, for some embodiments, offline digital Fast Fourier Transforms (FFTs) may be performed to transform the error data and remove high frequency components. This may be accomplished, for example, by setting all of the coefficients above a certain frequency, to zero. Accordingly, the lower frequency components may be unaffected resulting in essentially no phase or amplitude errors in the lower frequency components that were not set to zero.

The result of this filtering is illustrated in FIG. 3 which shows an exemplary plot 300 of positional errors along an X-trajectory, including both unfiltered errors (310) and filtered errors (320). In the illustrated example, low frequency noise is evident as increases in positional errors occurring at approximately 50 mm intervals. As previously described, such errors may coincide, for example, with the spacing of bolts fastening a bearing that guides stage movement. As illustrated, high frequency components in the plot of unfiltered errors 310 result in high frequency components in the corresponding unfiltered transform 330 (with non-zero high frequency coefficients). However, by setting these high frequency coefficients to zero, the high frequency coefficients of the transform (340) are removed entirely, resulting in the filtered plot 320 when an inverse transform is applied.

### CONCLUSION

Utilizing information regarding systematic tracking errors recorded during previous traversals of a trajectory by a movable stage, overall tracking errors of subsequent traversals of the same or similar trajectories may be significantly reduced.

While the foregoing is directed to embodiments of the present invention, other and further embodiments of the invention may be devised without departing from the basic scope thereof, and the scope thereof is determined by the claims that follow.

1. A method of reducing tracking errors in a motion control mechanism, comprising:
recording tracking errors during one or more traversals of one or more trajectories by a stage;
generating a positional error to control movement of the stage during a subsequent traversal of a similar or different trajectory;
adjusting the positional error based on at least one of the recorded tracking errors; and
utilizing the adjusted positional error to control the movement of the stage to a position during the subsequent traversal.

2. The method of claim 1, wherein generating a positional error comprises subtracting an actual position from a desired position and generating an output signal to move the stage.

3. The method of claim 1, wherein generating a positional error comprises adding back in previously recorded positional errors corresponding to the same or similar position.

4. The method of claim 3, further comprising storing the positional error in a lookup table.

5. The method of claim 4, further comprising retrieving a previously recorded positional error corresponding to a specific position from the lookup table.

6. The method of claim 1, further comprising utilizing a point-by-point scheme where multiple points along a trajectory are supplied in a command, allowing multiple recorded positional errors to be retrieved and utilized for compensation.

7. The method of claim 1, further comprising utilizing a point-to-point scheme where beginning and ending points are given.

8. The method of claim 1, further comprising filtering high frequency components from the recorded positional errors.

9. The method of claim 1, further comprising generating a running average of positional errors by recording and averaging a number of passes.

10. The method of claim 9, wherein utilizing the adjusted positional error to control the movement of the stage to a position during the subsequent traversal does not occur until a number of passes has been averaged.

11. A method of reducing tracking errors in a motion control mechanism, comprising:
recording tracking errors during one or more traversals of one or more trajectories by a stage;
filtering the recorded tracking errors to remove high frequency components; and
applying the filtered tracking errors to adjust position commands during subsequent passes along a similar trajectory.

12. The method of claim 11, wherein applying the filtered tracking errors, comprises:
generating a positional error to control movement of the stage during a subsequent traversal of a similar or different trajectory;
adjusting the positional error based on at least one of the recorded tracking errors; and
utilizing the adjusted positional error to control the movement of the stage to a position during the subsequent traversal.

13. The method of claim 12, wherein generating a positional error comprises adding back in previously recorded positional errors corresponding to the same or similar position.

14. The method of claim 13, further comprising storing the positional error in a lookup table.

15. The method of claim 14, further comprising retrieving a previously recorded positional error corresponding to a specific position from the lookup table.

16. A system for reducing tracking errors in a motion control mechanism, comprising:
a stage;
a stage controller adapted to generate control signals to move the stage along a desired trajectory; and
a systematic noise compensation logic adapted to record and process position errors during movement of the stage along a trajectory for use in compensating subsequent movement along the same or a similar trajectory.

17. The system of claim 16, wherein the stage controller includes the systematic noise compensation logic.

18. The system of claim 16, wherein the systematic noise compensation logic further includes memory to store position errors calculated as the stage makes one or more passes along a common trajectory or similar trajectories.

19. The system of claim 16, further comprising a charged particle beam.

20. The system of claim 16, further comprising a position measurement system.

21. The system of claim 20, wherein the position measurement system comprises a laser interferometer.
